(19) United States
(12) Patent Application Publication
(10) Pub. No.: US 2007/0059176 A1
(43) Pub. Date: Mar. 15, 2007

(54) Fluid moving device with low-drag impellers

(75) Inventors: Bret W. Lehman, Raleigh, NC (US); Beth F. Loebach, Raleigh, NC (US); Albert V. Makley, Raleigh, NC (US); Jason A. Matteson, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/226,970

(22) Filed: Sep. 15, 2005

(51) Int. Cl. B64C 11/06

(52) U.S. Cl. 416/147

(57) ABSTRACT

A cooling system for cooling a device in a computer system includes a plurality of cooling fans positioned in series. Each cooling fan includes a hub and at least one fan blade connected to the hub. The fan blade rotates relative to the hub about a substantially radially extending axis and between at least a first position and a second position. Drag to a flow of fluid through the cooling system by the fan blade in the second position is less than drag to the flow of fluid through the cooling system by the fan blade in the first position. Upon the hub rotating within the cooling fan, the fan blade is in the first position, and upon the hub stationary within the cooling fan, the fan blade is in the second position. The cooling system also includes a biasing member connected to the fan blade and the hub that biases the fan blade towards the second position.

### BACKGROUND OF THE INVENTION

1. Field of the Invention

The disclosure relates generally to cooling systems for computer systems and, more specifically, to a cooling system for reducing drag of fluid through a cooling fan of the cooling system.

2. Description of the Related Art

While the recent increase in the speed of microprocessors has significantly increased the processing capability of computers, this increase in speed has resulted in additional heat being generated by the processor and/or other components within a computer system. Many of these components, including the processor, are adversely affected by high temperatures; and thus, a need exists for dissipating the excess heat. Typically, a heat sink is thermally attached to an integrated circuit package containing the processor or other chip, and a cooling fan is used to force air over the heat sink.

One innovation for increasing cooling capacity has been to arrange multiple cooling fans in series, which results in the inlet of one fan being placed at the exhaust of another fan. This configurations increases the ability of the fans to overcome large pressure drops (i.e., resistance to flow or system impedance). Resistance to flow can created, for example, by mechanical structures such as a fan hub, fan impellers/blades, and fan struts that are located in front of or behind the cooling fan.

Problems can occur, however, with cooling systems that have multiple cooling fans in series upon one of the cooling fans failing or stalling. Upon such an occurrence, the stalled or failed cooling fan creates additional impedance for the working fan(s) in the cooling system. This additional impedance decreases air flow through the fans, which increases the potential that a component being cooled by the cooling system will become thermally degraded. There is, therefore, a need to improve multiple cooling fans in series such that if one of the multiple cooling fans stalls, a reduction of air flow through the cooling system is minimized.

### BRIEF SUMMARY OF THE INVENTION

Embodiments of the invention address deficiencies of the art of cooling system and provide a novel and non-obvious system for cooling a device in a computer system. The cooling system includes a plurality of cooling fans positioned in series. Each cooling fan includes a hub and at least one fan blade connected to the hub. The fan blade rotates relative to the hub about a substantially radially extending axis and between at least a first position and a second position. Drag to a flow of fluid through the cooling system by the fan blade in the second position is less than drag to the flow of fluid through the cooling system by the fan blade in the first position. Upon the hub rotating within the cooling fan, the fan blade is in the first position, and upon the hub stationary within the cooling fan, the fan blade is in the second position.

In another aspect of the cooling system, a biasing member is connected to the fan blade and the hub that biases the fan blade towards the second position. Also, the blade in the second position has a substantially zero coefficient of lift to a flow of fluid through the cooling system. Upon the blade having a symmetric profile, a cord line of the blade is substantially parallel to a freestream velocity of fluid through the cooling system and/or substantially parallel to a rotational axis of the cooling fan.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a side view of a cooling fan system configured in accordance with the inventive arrangements;

FIG. 2 is a larger side view of the cooling fan illustrated in FIG. 1;

FIGS. 3A, 3B are front views of the blades of the cooling fan respectively in a first position and in a second position.

FIGS. 4A, 4B are top views of a blade, having a first configuration, of the cooling fan respectively in the first position and in the second position;

FIGS. 5A, 5B are top views of a blade, having a second configuration, of the cooling fan respectively in the first position and in the second position;

FIGS. 6A, 6B are top views of a blade and biasing member of the cooling fan respectively in the first position and in the second position;

FIG. 7 is a graph representing experimental results of impedance of a cooling system having fans configured according to the prior art and of fans configured in accordance with the inventive arrangements; and

FIG. 8 is a graph representing experimental performance comparison of a cooling system having fans configured according to the prior art and of fan configured in accordance with the inventive arrangements.

### DETAILED DESCRIPTION OF THE INVENTION

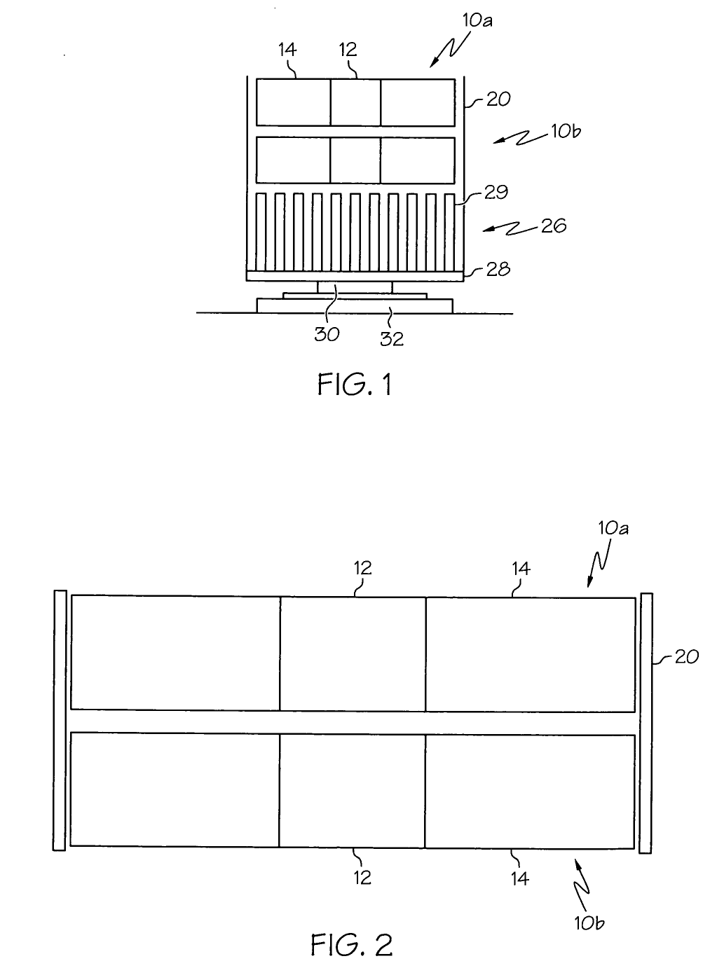

FIG. 1 illustrates a cooling device for a component of a computer system according to the present disclosure. The cooling device includes multiple fans 10a, 10b in series that direct a flow of fluid, such as air, through the cooling device. The fluid may be directed, for example, to a heat exchanger 26 that is thermally connected to the component, such as a computer processor 30. A shroud 20 may surround, at least in part, the fans 10a, 10b and the heat exchanger 26 to assist directing the flow of fluid from the fans 10a, 10b to the heat exchanger 26. Although not limited in this manner, the computer processor 30 may be seated within a socket 32 that is attached to circuit board.

Many different types of heat exchangers 26 capable of being used to cool a component of a computer system are known to those in the computer industry, and the present heat exchanger 26 is not limited to a particular type so capable. One type of heat exchanger 26, as illustrated, includes a heat sink 28 that is thermally connected to the processor 30 using, for example, a thermal paste. Fins 29 extend from the heat sink 28, and flow from the fans 10a, 10b is directed over surfaces on the fins 29 to cool the fins 29, which through a well-known mechanism, also cools the processor 30.

A closer view of one of the fans 10 according to the disclosure is illustrated in FIG. 2. The fan includes a hub 12 to which fan blades 14 are attached. The hub 12 is attached to a rotor/shaft (not shown) that is rotated, for example, by an electric motor. Alternatively, the blades 14 may be directly attached to the rotor/shaft, which also acts as the hub 12 of the fan 10.

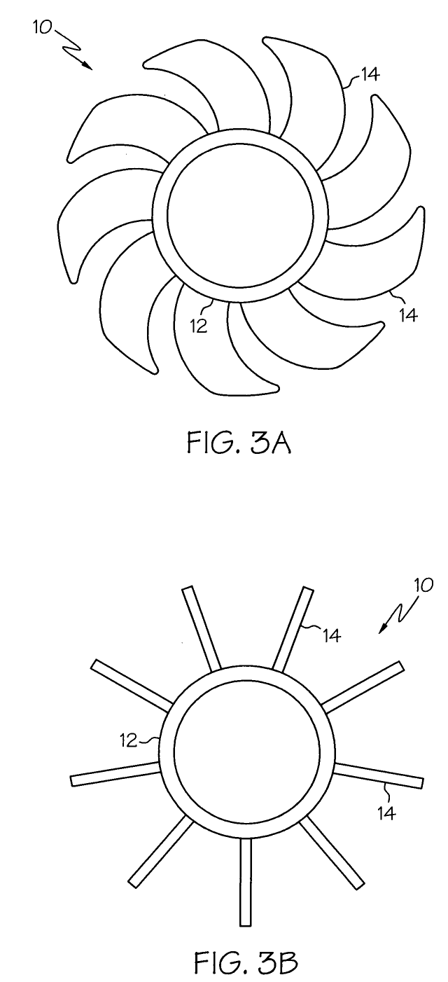

Referring to FIGS. 3A, 3B, 4A, 4B, and 5A, 5B, each fan blade 14 is rotated relative to the hub 12 and/or rotational axis RA of the fan 10 between at least a first position (FIGS. 3A, 4A, 5A) and a second position (FIGS. 3B, 4B, 5B) and about a substantially radially extending axis. In the first position, while the hub 12 and fan blades 14 are rotating, the fan blades 14 are positioned relative to the hub 12 and/or rotational axis RA of the fan 10 at a first angle θ_{R}. This first angle θ_{R} is comparable to an angle of attack, which is defined as the angle between the chord line. The chord line is defined as a straight line joining the leading edge of the fan blade 14 to the trailing edge of the fan blade 14, and the freestream velocity V_{∞} of the fluid through the cooling system. The first angle θ_{R} of the present fan 10, as is well known to those skilled in the art, may vary depending upon a multitude of variables, such as number of blades, operational RPM, torque capabilities of the device driving the fan 10, configuration of the blades, and desired flow through the fan 10.

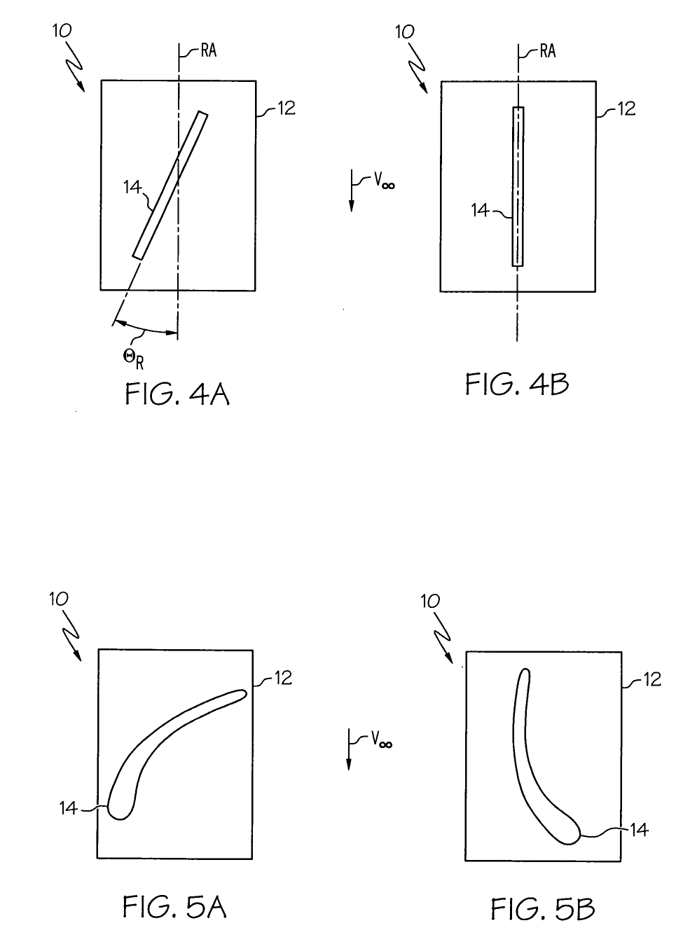

In the second position (FIGS. 3B, 4B, 5B), while the fan blades 14 are stationary, the fan blades 14 are positioned relative to the hub 12 and/or rotational axis RA at a second angle that reduces the resistance by the fan 10 to flow of fluid through the fan 10. For a fan blade 14 having a symmetric profile, such as illustrated in FIG. 4B, to minimize drag (i.e., resistance) of the fan blade 14, the fan blade 14 is positioned so as to have a substantially zero angle of attack relative to flow through the fan 10. In so doing, the chord line of the fan blade 14 is positioned to be substantially parallel with the rotational axis RA and/or direction of air flow through the fan 10.

For a fan blade 14 having an asymmetric/cambered profile (i.e., a non-linear mean line), such as illustrated in FIG. 5B, to minimize drag of the fan blade 14, the fan blade 14 is positioned so that the coefficient of lift of the fan blade 14 is substantially zero. Drag is a function of lift, and by reducing lift, drag is also reduced. For typical cambered airfoils, a slightly negative angle of attack results in a zero coefficient of lift. As is known to those skilled in the art, besides angle of attack, the coefficient of lift also depends on the shape of the airfoil (i.e., the fan blade 14); and thus, the angle of attack of the fan blade 14 that produces a substantially zero coefficient of lift is dependent upon the particular shape of the fan blade 14.

Many different devices can be used to move a fan blade 14 from the first position to the second position and from the second position to the first position, and the current cooling system is not limited as to a particular device so capable. For example, each fan blade 14 may be connected to the hub 12 with shafts that are rotated using servo-motors (not shown).

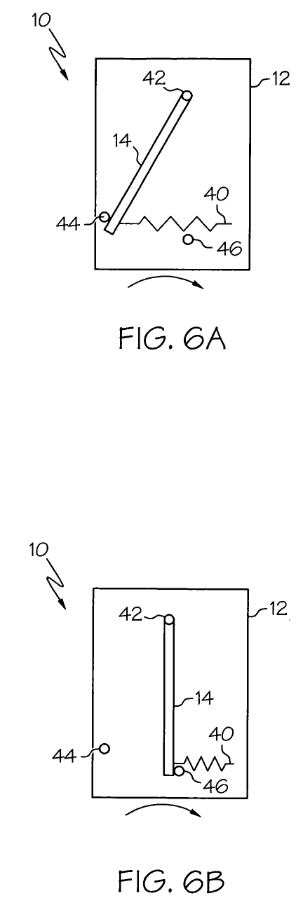

Another example of a device capable of moving the fan blades 14 between the first and second positions is described with reference to FIGS. 6A, 6B. The fan blade 14 can be connected to a biasing member 40 that biases the fan blade 14 towards the second position (i.e., the position of the fan blade 14 when stationary). The fan 10 is not limited as to a particular type or configuration of the biasing member 40. For example, the biasing member may be a torsion spring connected to a shaft that rotates the fan blade 14 toward the second position. As another example, the fan blade 14 may include the biasing member 40 as a flexible member.

Each fan blade 14 may include a respective biasing member 40. Alternatively, a plurality of the fan blades 14 may be connected through linkages (not shown) such that a single biasing member 40 moves all or a multiple number of the fan blades 14 between the first and second positions.

The fan blade 14 may be connected to the hub 12 at a pivot 42 such that biasing the fan blade 14 towards the second position rotates the fan blade 14 into the second position. Although not limited in this manner, the pivot 42 may be positioned proximate to a trailing edge of the fan blade 14.

The positioning device may also include stops 44, 46 for limiting the motion of the fan blade 14 between first position and the second position. For example, a first stop 44 may limit rotation of the fan blade 14 past the first position, and a second stop may limit rotation of the fan blade 15 past a second position. The use of stops 44, 46 to limit the relative motion of a particular device is well known, and the present fan 10 is not limited as to a particular type of stop 44, 46.

In operation, upon rotating the fan blade 14 in the direction shown by the arrow, force is exerted by the fluid against the fan blade 14 in a direction opposite the direction of rotation and against the force exerted by the biasing member 40. Upon the force created by the fluid against the fan blade 14 overcoming the force exerted by the biasing member 40 and any other force resistive to the fan blade 14 from moving, the fan blade 14 moves from the second position (FIG. 6B) into the first position (FIG. 6A). The fan blade 14 may remain in the first position until the fan blade 14 starts to stop rotating.

As the speed of rotation of the fan blade 14 is reduced, the force exerted against the fan blade 14 by the fluid also reduces. At a certain rotational speed of the fan blade 14, the force exerted by the fluid against the fan blade 14 is overcome by the force exerted against the fan blade 14 by the biasing member 40, and the fan blade 14 moves from the first position (FIG. 6A) into the second position (FIG. 6B).

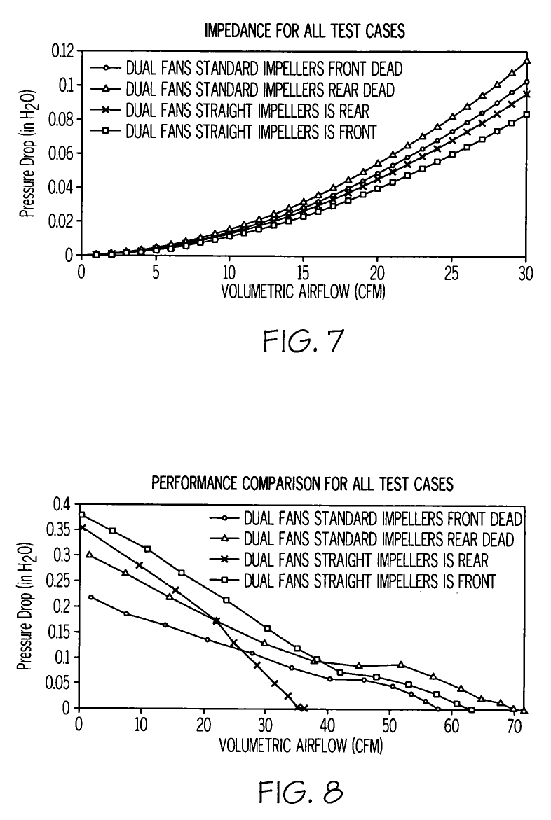

FIGS. 7 represents experimental results of the impedance of a cooling system having fans configured according to the prior art and of the presently disclosed cooling system. FIG. 8 is an experimental performance comparison of a cooling system having fans configured according to the prior art and of the presently disclosed cooling system. Both tested cooling systems included a pair of serially arranged fans (i.e., a front fan and a rear fan). To represent a “non-working” or dead fan, the blades/impellers of either the front fan or the rear fan were prevented from moving.

The blades/impellers used during the testing were substantially symmetrical. By being positioned in a “straight” configuration, the blades/impellers were substantially parallel to the rotational axis of the fans, and thus, the blades/impellers were positioned to minimize drag. As shown by these figures, a 20% reduction in impedance was realized, and as great as a 33% increase in airflow was realized.

What is claimed is:

1. A cooling system for cooling a device in a computer system, comprising:
a plurality of cooling fans positioned in series; and
each cooling fan including a hub and at least one fan blade connected to the hub; wherein
the fan blade rotates relative to the hub about a substantially radially extending axis and between at least a first position and a second position.

2. The cooling system according to claim 1, wherein drag to a flow of fluid through the cooling system by the fan blade in the second position is less than drag to the flow of fluid through the cooling system by the fan blade in the first position.

3. The cooling system according to claim 1, wherein
upon the hub rotating within the cooling fan, the fan blade being in the first position; and
upon the hub stationary within the cooling fan, the fan blade being in the second position.

4. The cooling system according to claim 1, wherein the blade in the second position having a substantially zero coefficient of lift to a flow of fluid through the cooling system.

5. The cooling system according to claim 1, wherein the blade having a symmetric profile, and a cord line of the blade being substantially parallel to a freestream velocity of fluid through the cooling system.

6. The cooling system according to claim 1, wherein the blade having a symmetric profile, and a cord line of the blade being substantially parallel to a rotational axis of the cooling fan.

7. The cooling system according to claim 1, further comprising a biasing member connected to the fan blade and the hub.

8. The cooling system according to claim 7, wherein the biasing member biases the fan blade toward the second position.

9. The cooling system according to claim 1, further comprising a least one stop to limit travel to at least the first position and/or the second position.

10. A computer system, comprising:
a device; and
a cooling system for cooling the device, the cooling system including
a plurality of cooling fans positioned in series, and
each cooling fan including a hub and at least one fan blade connected to the hub; wherein
the fan blade rotates relative to the hub about a substantially radially extending axis and between at least a first position and a second position.

11. The computer system according to claim 10, wherein drag to a flow of fluid through the cooling system by the fan blade in the second position is less than drag to the flow of fluid through the cooling system by the fan blade in the first position.

12. The computer system according to claim 10, wherein
upon the hub rotating within the cooling fan, the fan blade being in the first position; and
upon the hub stationary within the cooling fan, the fan blade being in the second position.

13. The computer system according to claim 10, wherein the blade in the second position having a substantially zero coefficient of lift to a flow of fluid through the cooling system.

14. The computer system according to claim 10, wherein the blade having a symmetric profile, and a cord line of the blade being substantially parallel to a freestream velocity of fluid through the cooling system.

15. The computer system according to claim 10, wherein the blade having a symmetric profile, and a cord line of the blade being substantially parallel to a rotational axis of the cooling fan.

16. The computer system according to claim 10, further comprising a biasing member connected to the fan blade and the hub.

17. The computer system according to claim 16, wherein the biasing member biases the fan blade toward the second position.

18. The computer system according to claim 10, further comprising a least one stop to limit travel to at least the first position and/or the second position.

19. A cooling system for cooling a device in a computer system, comprising:
a plurality of cooling fans positioned in series; and
each cooling fan including a hub and at least one fan blade connected to the hub; wherein
the fan blade rotates relative to the hub about a substantially radially extending axis and between at least a first position and a second position,
drag to a flow of fluid through the cooling system by the fan blade in the second position is less than drag to the flow of fluid through the cooling system by the fan blade in the first position,
upon the hub rotating within the cooling fan, the fan blade being in the first position, and
upon the hub stationary within the cooling fan, the fan blade being in the second position.

20. The cooling system according to claim 19, further comprising a biasing member connected to the fan blade and the hub and for biasing the fan blade toward the second position.
